(19) United States
(12) Patent Application Publication
(10) Pub. No.: US 2010/0116426 A1
(43) Pub. Date: May 13, 2010

(54) LABELING DEVICE

(75) Inventor: Georg Austermeier, Hoevelhof (DE)

Correspondence Address: BROOKS KUSHMAN P.C., 1000 TOWN CENTER, TWENTY-SECOND FLOOR, SOUTHFIELD, MI, 48075, US

(73) Assignee: MR ETIKETTIERTECHNIK GMBH & CO. KG, Enger (DE)

(21) Appl. No.: 12/615,057

(22) Filed: Nov. 9, 2009

(30) Foreign Application Priority Data
Nov. 10, 2008 (DE) 10 2008 056 660.8

(51) Int. Cl. B65C 9/08; B65C 9/30

(52) U.S. Cl. 156/238; 156/556

(57) ABSTRACT

The invention relates to a labeling device and method for attaching in particular elongated narrow labels. In the labeling device, a respective label dispensed from a dispensing edge is only partially received by a conveying belt. The conveying belt is moved into a position in which a portion of the label projecting from the conveying belt is attached at an item to be labeled. The conveying belt may be crossed by 90° while it passes a drive roll and a roller.

### CROSS-REFERENCE TO RELATED APPLICATIONS

This application claims foreign priority benefits under 35 U.S.C. §119(a)-(d) to German patent application number DE 10 2008 056660.8, filed Nov. 10, 2008, which is hereby incorporated by reference in its entirety.

### BACKGROUND

1. Field of the Disclosure

The disclosure relates to a labeling device and method for attaching labels.

2. Background Art

Labeling devices for attaching in particular elongated narrow labels, such as for example sealing labels, are known from prior art. In these labeling devices, labels provided at a backing tape are dispensed directly to the item to be labeled by means of a dispensing edge. In practice, it might be necessary to attach elongated narrow labels to the neck of a bottle. That means that the same label must be attached to a front face as well as to a circumferential surface of the neck of the bottle.

To satisfy this requirement, an embodiment is known where the labeling device is arranged above a product conveying belt on which the bottles are conveyed. The dispensing edge is arranged with respect to the bottles such that, when the labeling device is in operation, the label dispensed at the dispensing edge adheres to the front face of the neck of the bottle and is thus taken along by the same. For this, it is necessary for the label to be separated from the backing tape at the dispensing edge such that the adhesive side of the label faces the front face of the bottle. In addition, it is necessary for the dispensing edge to be oriented in the direction of transport of the product conveying belt. Subsequently to the taking along of the label by means of the neck of the bottle, the portion of the label projecting from the neck of the bottle is pressed to the circumferential surface of the neck of the bottle by means of a very complex pressing mechanism. This pressing mechanism must ensure that the label is pressed without the transport of the bottle being hindered. Another disadvantage of the above-described embodiment is that the labeling device is arranged above the item to be labeled. This renders the operation of the labeling device, for example the exchange of the supply reel, difficult.

### SUMMARY

The object underlying the present disclosure is now to provide a labeling device in which a space-saving construction and ergonomic operation may be achieved. Another object is to make labeling as easy as possible.

The advantages achieved by the invention are in particular that the use of a crossing conveying belt which conveys the labels permits to do without a complex pressing mechanism.

The crossing of the conveying belt can be adjusted, so that a simple and reproducible adjustment of the label position is possible. Another advantage is that almost any arbitrary position can be easily achieved by crossing and/or deflecting the conveying belt. It is moreover possible to realize the attaching of the labels to the item to be labeled in a simple manner. For this, the conveying belt conveys the respective dispensed label to a position where the portion of the label projecting from the conveying belt is attached to the item to be labeled. As in the labeling device according to the invention no complex pressing mechanism is required, the assembly space required for the labeling device is reduced. Another advantage of the invention is that it is no longer necessary to arrange the labeling device above the item to be labeled. Consequently, the operation of the labeling device is facilitated.

Another advantageous development of the invention is that the labels are provided with their adhesive sides at the conveying belt. This ensures that the labels can be conveyed from the position where they are dispensed to a second position where they are attached to the item to be labeled in a simple manner and without the use of any further components.

Another advantageous development of the invention consists in the label being provided at the backing tape with its elongated side transverse to the direction of transport of the backing tape. Thus, the number of labels provided on the backing tape per supply reel is clearly higher than in case of a supply reel where the elongated side of the label is oriented in parallel to the moving direction of the backing tape. Thus, much more labels can be accommodated on the supply reel, and the reel must be exchanged less often, which considerably increases efficiency. Moreover, the assembly space required for the labeling device is thereby reduced, e.g. as it is no longer necessary to provide several supply reels at the labeling device. It is furthermore advantageous for a width of the backing tape to approximately correspond to the length of the elongated side of the label. A backing tape embodied in such a manner can be easily reeled on a collecting reel after the dispensing procedure. The problem of preventing the already reeled backing tape from partially peeling off from the collecting reel, which problem arises with narrow backing tapes, can be prevented by a broader backing tape according to the invention.

Another advantage of the above mentioned arrangement of the labels on the backing tape is that a dispensing speed of the labels does not have to correspond to the transport speed of the items to be labeled but may be essentially slower. Thus, the risk of the backing tape tearing in particular when it passes the dispensing edge is reduced.

Details of the invention are illustrated more in detail with reference to the drawings.

### BRIEF DESCRIPTION OF THE DRAWINGS

FIG. 1 shows a perspective view of a part of a labeling device;

FIG. 2 shows a front view of a labeling device; and

FIG. 3 shows a plan view of a labeling device.

### DETAILED DESCRIPTION

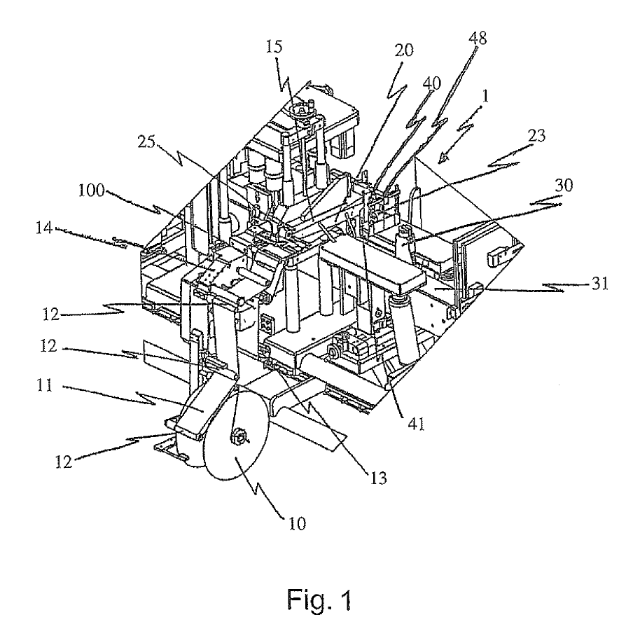

A labeling device 1 according to FIG. 1 comprises a housing 14, 15, composed of a box-shaped housing 14 and a housing section 15 projecting from the box-shaped housing 14. A supply reel 10 of a backing tape 11 provided with labels 100 is rotatably mounted at the box-shaped housing 14. The projecting housing section 15 extends transversely to a product conveying belt 31 by means of which the items to be labeled 30 are conveyed. At the side of the box-shaped housing 14 facing the supply reel 10, several deflection rolls 12, a drive mechanism for driving the backing tape 11, and a collecting reel 13 for reeling the empty backing tape 11 after the labels 100 have been dispensed, are provided.

In this embodiment, the labels 100 are each designed as elongated narrow labels with an adhesive and a non-adhesive side. They are provided with their adhesive sides on the backing tape 11, so that a secure conveyance of the labels 100 by the backing tape 11 is ensured. Furthermore, the labels 100 are provided on the backing tape 11 with their elongated sides being transverse to the direction of transport of the backing tape 11. Embodiments that are not elongated are also conceivable for the labels.

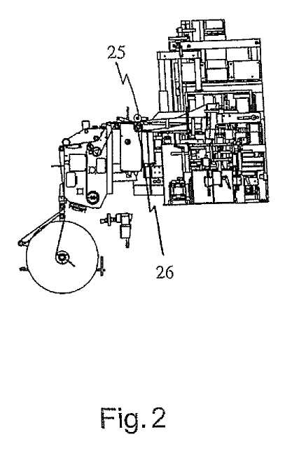

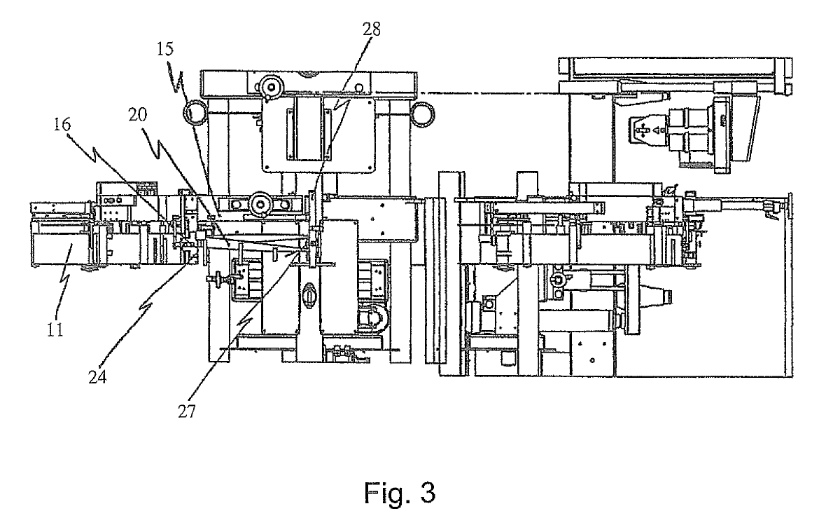

The labeling device 1 comprises a dispensing edge 24 shown in FIG. 3 for dispensing the labels 100 from the backing tape 11 to a conveying belt 20. Furthermore, the labeling device 1 comprises a roller 25 located near the dispensing edge 24 which is connected to the housing 14, 15 via an arm. The conveying belt 20 located opposite the dispensing edge 24 is in this region, as can be taken from FIG. 2, arranged at the same level as the backing tape 11. Consequently, the labels 100 dispensed from the dispensing edge 24 can be easily received by the conveying belt 20. The distance between the conveying belt 20 and the dispensing edge 24 is selected such that the dispensed labels 100 can each be received and taken along by the conveying belt 20.

The width of the conveying belt 20 transverse to the direction of transport is smaller than the width of the backing tape 11. Thus, it is possible that only a portion of the label 100 dispensed from the dispensing edge 24 is received by the conveying belt 20. Thus, a label portion which projects from the conveying belt 20 is necessarily formed. The portion of the label 100 that is connected to the conveying belt 20 is smaller than the portion of the label 100 projecting from the conveying belt 20. The connection of the label 100 with the conveying belt 20 is accomplished by contacting the adhesive side of the labels 100 with the conveying belt 20.

The roller 25 serves to support the transfer of the label 100 dispensed from the dispensing edge 24 to the conveying belt 20 by pressing the dispensed label 100 towards the conveying belt 20. Moreover, embodiments are conceivable where the roller 25 is driven by a motor and, as a result of the rotation, exerts a force on the dispensed label towards the conveying belt 20.

The conveying belt 20 can be embodied, for example, as a belt and it passes about a roll 27 represented in FIG. 3 and a drive roll 26 represented in FIG. 2. The drive roll 26 is coupled to a drive unit which is not represented in FIGS. 1 and 3 and serves to drive the conveying belt 20. The roll 27 is oriented with respect to the drive roll 26 such that an angle is formed between an axis of the roll 27 and an axis of the drive roll 26, when seen in the direction of transport of the conveying belt 20. Such an orientation of the roll 27 with respect to the drive roll 26 results in a crossing or twisting of the conveying belt 20 when the same is circulating.

In the shown embodiment, an angle of 90° is formed between the roll axis and the drive roll axis, when seen in the direction of transport of the conveying belt 20. That means that the conveying belt 20 is crossed or twisted by 90° when the roll 27 and the drive roll 26 are circulating. Moreover, embodiments are conceivable where an angle different from 90° is adjusted between the drive axis and the roll axis.

The drive roll 26 is connected to the housing 14, 15 via a non-depicted arm. The drive roll 26 projects from the housing 14, 15 in the same direction as the deflection rolls 12, the roller 15 and the collecting reel 13, the respective axes being in parallel to each other. The exact positioning of the drive roll 26 on the housing 14, 15 is selected such that the part of the conveying belt 20 receiving the labels 100 is at the same level as the backing tape 11 located at the dispensing edge 24. The roll 27 is connected to the projecting housing section 15 via an arm 40.

At the end of the arm 40 distal with respect to the projecting housing section 15, a pressing mechanism 23 is provided for pressing a label portion projecting from an item to be labeled 30 to a front face of the item 30. The pressing mechanism 23 comprises a pressing roll swiveling transversely to an axis of the arm 40. The pressing roll is provided on the arm such that it can be brought into contact with the item to be labeled 30 conveyed on the product conveying belt 31.

A deflection element 41 is arranged at the arm 40 between the end of the arm 48 at which the pressing mechanism 23 is arranged and the roll 26. The deflection element 41 serves to deflect the portion of the labels 100 projecting from the conveying belt 20 towards the item to be labeled 30 conveyed by the product conveying belt 31. The deflection element 41 is embodied such that it does not hinder the movement of the items to be labeled 30 conveyed by the product conveying belt 31.

FIG. 2 shows a front view and FIG. 3 a plan view of a labeling device. As can be taken from FIG. 3, the dispensing edge 24 is an edge of a non-depicted element oriented transversely to the direction of transport of the backing tape 11. The element can be embodied as strip-like plate and is fixed to the box-shaped housing 14. A pressing element 16 arranged near the dispensing edge 24 and connected to the box-shaped housing 14 serves to support the transfer of the dispensed label 100 to the conveying belt 20.

Below, the method followed in the labeling device 1 will be described. The backing tape 11, on which the labels 100 are first situated, is peeled off from the supply reel 10 and passes to the dispensing edge 24 via a plurality of deflection rolls 12. After the passing of the dispensing edge 24, the backing tape 11, which is rid of the labels 100, passes to the collecting reel 13 which is in this case embodied as a winder.

The labels 100 that are released from the backing tape 11 at the dispensing edge 24 are received by the conveying belt 20. The labels are dispensed such that the adhesive sides of the labels 100 are connected with the conveying belt 20. The roller 25 exerts force acting in the direction of the conveying belt 20, such that the respective label 100 adheres to the conveying belt 20. As the width of the conveying belt 20 is smaller than the width of the backing tape 11, only a portion of the label 100 is received by the conveying belt 20. Due to the above mentioned arrangement of the drive roll 27 and the roll 26, the conveying belt 20, and thus also the labels 100, is crossed while it passes about the drive roll 27 and the roll 26.

In detail, the conveying belt 20 passes the following positions. Starting from the position where the conveying belt 20 receives the dispensed labels 100 (hereinafter referred to as first position), the belt passes to a position in which the portion of the labels projecting from the conveying belt 20 is deflected by the deflection element 41.

The deflection causes the portion of the label 100 projecting from the conveying belt 20 to be deflected towards the item to be labeled 30. Consequently, the adhesive side of the respective label 100 faces the item to be labeled. In this position of the conveying belt 20, the same is not yet crossed by 90°. Subsequently, the conveying belt 20 passes to a second position. In this second position, the conveying belt 20 is crossed by 90° compared to the position of the conveying belt 20 in the first position. The second position is selected such that the portion of the label 100 projecting from the conveying belt 20 can be contacted with the item to be labeled 30. In this case, the portion of the label 100 projecting from the conveying belt 20 is perpendicular to the direction of transport of the product conveying belt 31.

The item to be labeled 30 is arranged on a product conveying belt 31 which moves transversely to the direction of transport of the conveying belt. The item to be labeled 31 is in this case a bottle with a neck. However, other items are also conceivable. In a predetermined position of the conveying belt 31, a circumferential surface of the conveyed bottle comes into contact with the portion of the label 100 projecting from the conveying belt 20. As an adhesive strength between the portion of the label 100 connected to the conveying belt 20 is smaller than an adhesive strength between the portion of the label 100 projecting from the conveying belt 20 and the bottle, the portion of the label 100 connected to the conveying belt 20 is separated when the bottle is conveyed into a direction departing from the conveying belt 20.

The label 100 is attached to the bottle such that the portion of the label 100 projecting from the conveying belt 20 adheres to a circumferential surface of the neck of the bottle or the body of the bottle. The section of the label 100 originally connected to the conveying belt 20 now projects from the bottle. This section projecting from the bottle is pressed to the front face of the bottle by means of the pressing mechanism 23.

In this respect, the bottle passes a position during the movement of the product conveying belt 31 departing from the conveying belt 20, in which the portion of the label 100 projecting from the bottle is pressed to the front face of the bottle by the pressing mechanism 23. The pressing mechanism is in this case embodied as a pressing roll which is swiveling transversely to the axis of the arm 40. The pressing roll is provided between the product conveying belt 31 and the arm 40. The distance between the arm and the pressing roll is selected such that the pressing roll is contacted with the bottle, but the bottle is not hindered from being further conveyed by the product conveying belt 31.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A labeling device for attaching adhesive labels that are provided on a backing tape, the labeling device comprising:
a dispensing edge;
a drive mechanism for pulling the backing tape toward the dispensing edge to dispense a label; and
a conveying belt for receiving only a portion of the label dispensed at the dispensing edge, wherein the conveying belt is movable from a first position, in which the dispensed label is received, into a second position, in which the label is dispensed to an item to be labeled, and wherein the conveying belt is twisted during the movement between the first and the second positions.

2. The labeling device according to claim 1 wherein the backing tape and a side of the conveying belt receiving the label are arranged in the first position of the conveying belt at the same level.

3. The labeling device according to claim 1 further comprising a product conveying belt for conveying the item to be labeled, wherein the conveying belt is arranged transversely to the product conveying belt.

4. The labeling device according to claim 1 wherein the backing tape has a tape width and the conveying belt has a belt width that is smaller than the tape width.

5. The labeling device according to claim 1 wherein the label has an adhesive side, and wherein in the second position a portion of the label projects from the conveying belt such that the adhesive side faces a circumferential surface of the item to be labeled.

6. The labeling device according to claim 5 wherein an adhesive strength between the portion of the label received by the conveying belt and the conveying belt is smaller than an adhesive strength between the portion of the label projecting from the conveying belt and the circumferential surface of the item to be labeled.

7. The labeling device according to claim 1 wherein the conveying belt is twisted 90° between the first and the second positions.

8. The labeling device according to claim 1 further comprising a pressing mechanism for pressing a portion of the label projecting from the item to be labeled to a front face of the item to be labeled.

9. The labeling device according to claim 8 wherein the pressing mechanism comprises s swiveling pressing roll.

10. The labeling device according to claim 1 wherein the labels is embodied as an elongated narrow label.

11. The labeling device according to claim 10 wherein an elongated side of the label is oriented transversely to a direction of transport of the backing tape.

12. The labeling device according to claim 1 further comprising a roll about which the conveying belt passes, and a drive roll that drives the conveying belt, wherein the roll has a roll axis and the drive roll has a drive roll axis, and wherein the roll is oriented such that an angle is formed between the roll axis and the drive roll axis when viewed in a direction of transport of the conveying belt.

13. A method for attaching labels, the method comprising:
conveying a backing tape on which labels are provided to a dispensing edge;
dispensing a label at the dispensing edge to a conveying belt, wherein the conveying belt only receives a portion of the label; and
conveying the conveying belt with the received label to an item to be labeled, wherein the conveying belt is twisted during the conveyance of the label to the item to be labeled.

14. The method according to claim 13 wherein the labels are supplied transversely to the direction of transport of the item to be labeled.

15. The method according to claim 13 wherein the backing tape has a tape width and the conveying belt has a belt width that is smaller than the tape width.

16. The method according to claim 15 wherein during conveying the conveying belt, a portion of the label projects from the conveying belt such that an adhesive side of the label faces a surface of the item to be labeled.

17. The method according to claim 13 wherein the conveying belt is twisted 90° during the conveyance of the label to the item to be labeled.

18. The method according to claim 13 wherein the conveying belt passes about a roll and a drive roll, wherein the roll has a roll axis and the drive roll has a drive roll axis, and wherein the roll is oriented such that an angle is formed between the roll axis and the drive roll axis when viewed in a direction of transport of the conveying belt.
